(19) United States
(12) Patent Application Publication
(10) Pub. No.: US 2004/0235452 A1
(43) Pub. Date: Nov. 25, 2004

(54) Network access point for providing multiple levels of security

(76) Inventors: Michael Andrew Fischer, San Antonio, TX (US); Timothy Gordon Godfrey, Overland Park, KS (US)

Correspondence Address: DEMONT & BREYER, LLC, SUITE 250, 100 COMMONS WAY, HOLMDEL, NJ, 07733, US

(21) Appl. No.: 10/443,391

(22) Filed: May 22, 2003

(51) Int. Cl. H04M 1/66

(52) U.S. Cl. 455/410; 455/411

(57) ABSTRACT

A technique is disclosed to provide a single wireless local area network in which authorized wireless stations and non-authorized wireless stations can associate with different security levels and privileges. In the first illustrative embodiment of the present invention, there are multiple physical or logical ports connecting a wireless station to public and private resources. The purpose of using multiple ports to access the external resources is to segregate the traffic associated with each level of security to a different port, and to ensure that each external resource only accepts traffic from those ports that are associated with the level of security needed for that resource. In the second illustrative embodiment of the present invention, segregation of traffic associated with each level of security is achieved by putting resources of different levels of security or privilege on different virtual local area networks.

### FIELD OF THE INVENTION

The present invention relates to telecommunications in general, and, more particularly, to telecommunications network access points for internetworking.

### BACKGROUND OF THE INVENTION

Before the 1980's, most computer users shared the resources of a single mainframe computer, and the centralized nature of the mainframe enabled those users to easily share information with each other. In the 1980's, increasing numbers of computer users has a personal computer, and the distributed nature of the personal computers hindered those users from sharing information.

In fact, the most common way of transporting information from one personal computer to another in the early 1980's was by physically carrying a floppy disk from one machine to another. This was widely known as, and facetiously called, a “sneaker net.”

Sneaker nets are tedious and slow, and, therefore, local area networks were created to replace them. The first local area networks had metal wires that interconnected the computers, but in the 1990's, local area networks that used radios, instead of wires, became popular. Furthermore, as local area networks proliferated, it became common for users with stations on one local area network to desire access to resources on another local area network. This resulted in the development of the router or gateway, which enabled internetworking.

FIG. 1 depicts a block diagram of the salient components of a telecommunications system in the prior art in which a station on a first local area network desires access to a resource on a second local area network. Telecommunications system 100 comprises: wireless station 101, access point 102, resources 103-1 and 103-2, firewall 104, authentication server 105, the Internet, wireless local area network 110, and wireline local area network 111.

Wireless station 101 and access point 102 communicate via wireless local area network 110, and access point 102 communicates with resources 103-1 and 103-2, firewall 104, and authentication server 105 via wireline local area network 111. Because access point 102 has a presence in both local area networks, it acts as a bridge between wireless local area network 110 and wireline local area network 111 and enables wireless station 101 to access resources 103-1 and 103-2.

When either or both of resources 103-1 and 103-2 are open to the public, access point 102 can let any wireless station have access to them. In contrast, when one or both of resources 103-1 and 103-2 are private (i.e., proprietary or confidential), access point 102 might restrict access to only stations that can authenticate themselves (e.g., by providing a password, etc.) to authentication server 105 to prove that they are authorized to have access to the resources.

Geographic locations exist where one wireless station only needs access to public resources and yet another wireless station needs access to private resources. A hotel is one example of such a location. The hotel manager needs access to private resources and the guests need access to public resources (e.g., the Internet, etc.).

In this case, two pairs of networks are typically provided to isolate and protect the private resources from users who are not authorized to access them. The first pair of networks provide access to the public resources and the second pair of networks provide access to the private resources. This is depicted in FIG. 2.

FIG. 2 depicts a block diagram of the salient components of telecommunications system 200 in the prior art, which provides one pair of networks for access to public resources and another pair of networks for access to private resources. Telecommunications system 200 comprises: wireless stations 201-1 and 201-2, access points 202-1 and 202-2, private resource 203-1, public resource 203-2, firewalls 204-1 and 204-2, authentication server 205, wireless local area networks 210-1 and 210-2, wireline local area networks 211-1 and 211-2, and the Internet, interconnected as shown.

To access private resource 203-1, a wireless station must authenticate itself to authentication server 205 to prove that is authorized to have access to the resources. To access public resource 203-2, a wireless station need not authenticate itself.

The architecture in FIG. 2 is disadvantageous, however, in that it requires two access points and two firewalls, which are costly. Therefore, the need exists for a more economical system that enables authorized access to private resources, public access to public resources, and adequately protects the private resources from unauthorized access.

### SUMMARY OF THE INVENTION

The present invention enables authorized access to private resources, public access to public resources, and adequately protects the private resources from unauthorized access without some of the costs and disadvantages associated with systems in the prior art. In accordance with the illustrative embodiments, a single access point is provided that is capable of: (i) allowing authorized users to access private resources, (ii) allowing all users to access public resources, and (iii) hindering the hacking of the public resources to gain access to the private resources. Two illustrative embodiments are described in which this is accomplished.

In accordance with the first illustrative embodiment, the access point has a plurality of ports—either physical, logical, or a combination of physical and logical—that provide access to the public and private resources. Each port is associated with a level of security, or nature of privilege, or both, and the resources associated with a given level of security or privilege are accessible only via that port. For example, the first port is associated with a first level of security and the publicly-accessible resources are accessible only via that port, and the second port is associated with a second level of security and the private resources are only accessible via that port.

Furthermore, the private resources are configured to only accept traffic from the second port. This prevents traffic from a hacked publicly-accessible resource from bypassing the access point to access a private resource.

A user-desiring access to a public resource is granted access through the first port. A user desiring access to a private resource is authenticated through the first port, and if the authentication succeeds, the access point provides that user access to the private resource through the second port.

In accordance with the second illustrative embodiment, the access point has a plurality of virtual local area networks—but one physical local area network—that provide access to the public and private resources. Each virtual local area network is associated with a level of security, or nature of privilege, or both, and the resources associated with a given level of security or privilege are accessible only via that virtual local area network. For example, the first virtual local area network is associated with a first level of security and the publicly-accessible resources are accessible only via that virtual local area network, and the second virtual local area network is associated with a second level of security and the private resources are only accessible via that virtual local area network.

Furthermore, the private resources are configured to only accept traffic from the second virtual local area network. This prevents traffic from a hacked publicly-accessible resource from bypassing the access point to access a private resource.

A user desiring access to a public resource is granted access through the first virtual local area network. A user desiring access to a private resource is authenticated through the first virtual local area network, and if the authentication succeeds, the access point provides that user access to the private resource through the second virtual local area network.

The first illustrative embodiment comprises: receiving a request from a first wireless station for access to a first resource, wherein the first wireless station offers to authenticate itself as authorized to access the first resource; authenticating the first wireless station through a first port; and, providing access for the first wireless station to the first resource through a second port after the first wireless station has been authenticated as authorized to access the first resource.

### BRIEF DESCRIPTION OF THE DRAWINGS

FIG. 1 depicts a schematic diagram of a portion of a typical wireless telecommunications system of the prior art.

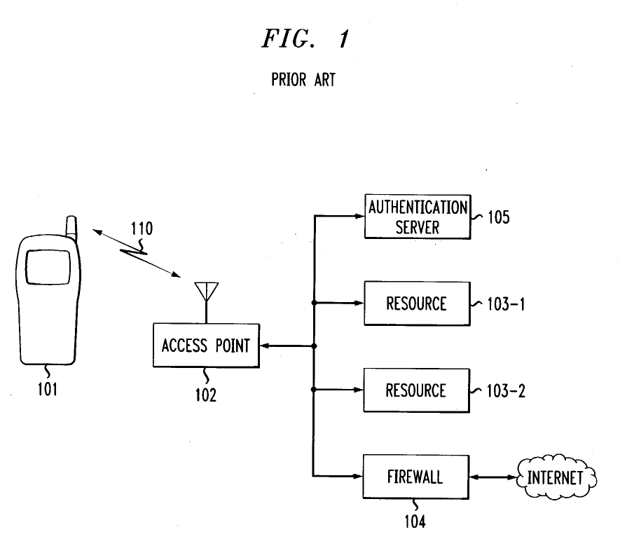

FIG. 2 depicts a portion of two parallel wireless networks of the prior art, one for access to public resources, and one for access to private resources.

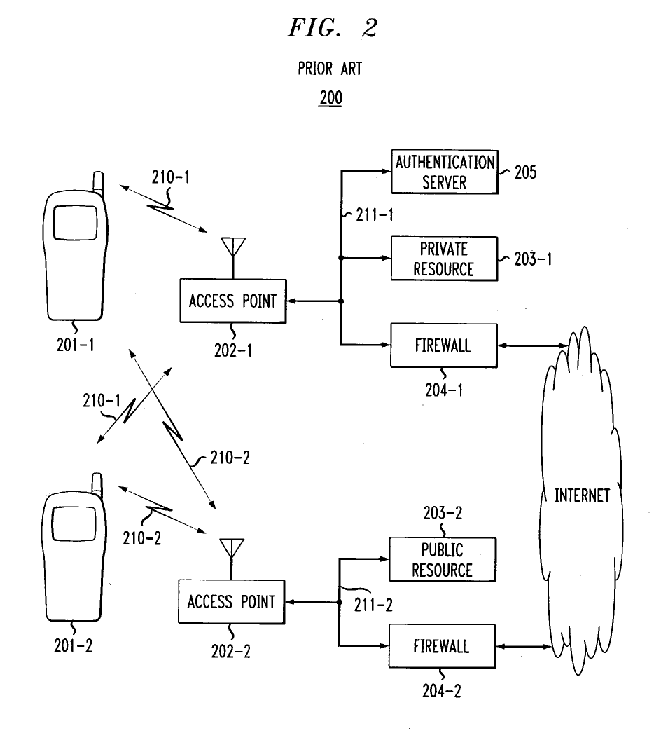

FIG. 3 depicts a block diagram of the salient components of the first illustrative embodiment of the present invention.

FIG. 4 depicts a block diagram of the salient components of Access point 302.

FIG. 5 depicts the message flows associated with the first illustrative embodiment of the present invention for the case in which wireless station 301-1, which seeks access to a public (low/no security) resource.

FIG. 6 depicts the message flows associated with the first illustrative embodiment of the present invention for the case in which wireless station 301-2, which seeks access to both a public (low/no security) resource and a confidential (medium security) private resource.

FIG. 7 depicts the message flows associated with the first illustrative embodiment of the present invention for the case in which wireless station 301-3, which seeks access to a public (low/no security) resource, a confidential (medium security) private resource, and a secret resource.

FIG. 8 depicts the message flows associated with the first illustrative embodiment of the present invention for the case in which wireless station 301-4, which seeks access to secret resource 304-3 and public resource 304-1, but fails to be authenticated to access secret resource 304-3.

FIG. 9 contains all the same elements as FIG. 3, except that access point 902 is interconnected to the resources, firewalls, and authentication server via virtual private local area networks instead of physical port connections.

FIG. 10 depicts a block diagram of the salient components of Access point 902.

FIG. 11 depicts an event diagram of the salient tasks performed by access point 902 in accordance with the second illustrative embodiment of the present invention for the case in which wireless station 901-1, which seeks access to a public (low/no security) resource. Because wireless station 901-1 only seeks access to a public resource, access point 902 communicates with that resource only through virtual local area network 906-1.

FIG. 12 depicts an event diagram of the salient tasks performed by access point 902 in accordance with the second illustrative embodiment of the present invention for the case in which wireless station 901-2, which seeks access to both a public (low/no security) resource and a confidential (medium security) private resource.

FIG. 13 depicts an event diagram of the salient tasks performed by access point 902 in accordance with the second illustrative embodiment of the present invention for the case in which wireless station 901-3, which seeks access to a public (low/no security) resource, a confidential (medium security) private resource, and a secret resource.

FIG. 14 depicts an event diagram of the salient tasks performed by access point 902 in accordance with the second illustrative embodiment of the present invention for the case in which wireless station 901-4, which seeks access to secret resource 904-3 and public resource 904-1, but fails to be authenticated to access secret resource 904-3.

### DETAILED DESCRIPTION

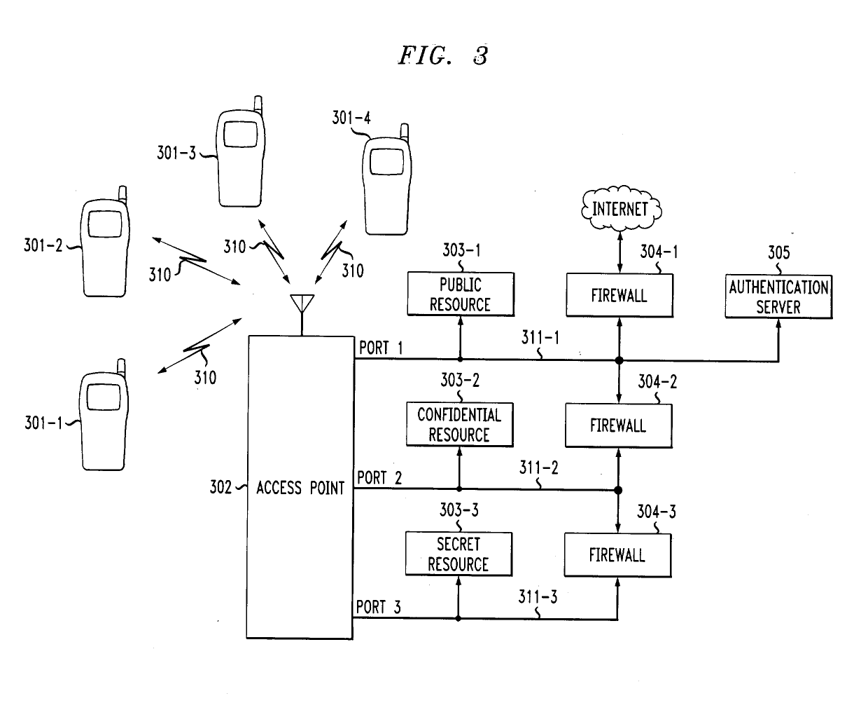

FIG. 3 depicts a block diagram of the salient components of the first illustrative embodiment of the present invention. Telecommunications system 300 comprises: wireless stations 301-1 through 301-4, access point 302, public resource 303-1, confidential resource 303-2, secret resource 303-3, firewalls 304-1 through 304-3, authentication server 305, wireless local area network 310, wireline local area network 311, and the Internet, which are interconnected as shown.

Wireless local area network 310 is IEEE 802.11 compliant, as are wireless stations 301-1 through 301-4 and access point 302. It will be clear to those skilled in the art how to make and use wireless stations 301-1 through 301-4. Furthermore, it will be clear to those skilled in the art, after reading this specification, how to make and use embodiments of the present invention in which wireless local area network 310 operates in accordance with a different protocol.

Wireline local area network 311 is Ethernet compliant, as are access point 302, firewalls 303-1 and 303-2, public resource 304-1, confidential resource 304-2, secret resource 304-3, and authentication server 305. It will be clear to those skilled in the art how to make and use firewalls 303-1 and 303-2, public resource 304-1, confidential resource 304-2, secret resource 304-3, and authentication server 305. Furthermore, it will be clear to those skilled in the art, after reading this specification, how to make and use embodiments of the present invention in which local area network 311 operates in accordance with a different protocol.

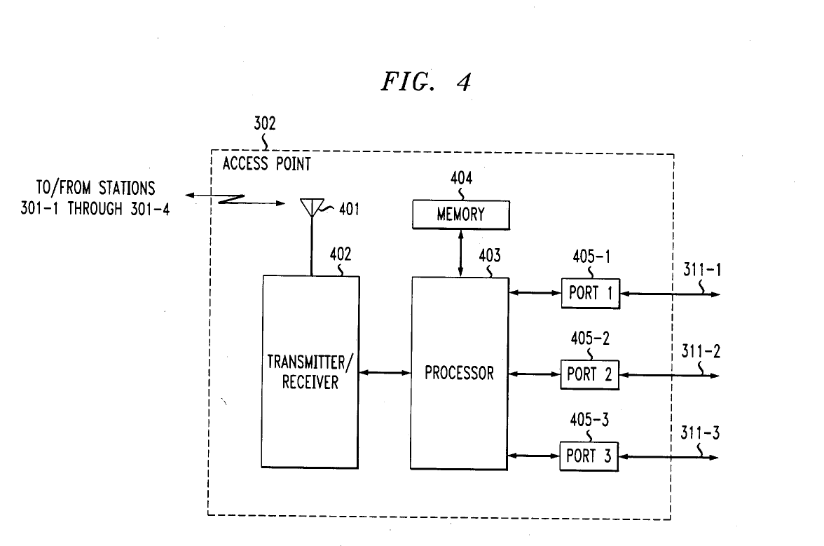

Access point 302 provides a bridge through which both authorized and unauthorized (i.e., guest) wireless stations can access both public and private resources based on their respective security and privilege level. The details of access point 302 are described below and with respect to FIG. 4.

Resources 303-1 through 303-3 are general-purpose computers that comprise information (e.g., databases, web sites, etc.) that the users of wireless stations 301-1 through 301-4 might desire to access. In accordance with the illustrative embodiment, resource 303-1 comprises public information that can be accessed freely by anyone for any purpose. In contrast, resources 303-2 and 303-3 comprise private information that can be accessed only by individuals with the privilege level to do so. Furthermore, resource 303-2 comprises secret information, which is more closely guarded than is the information in confidential resource 303-2. Confidential resource 303-2 is configured to only accept traffic emanating from Port 303-303-2 of access point 302 and secret resource is configured to only accept traffic emanating from Port 303-3 of access point 302. It will be clear to those skilled in the art how to make and use resources 303-1 through 304-3.

Firewalls 304-1 through 304-3 are each general-purpose computers that prevent unauthorized access to the resources behind them. Because of the relative sensitivity of the data in public resource 303-1, confidential resource 303-2, and secret resource 303-3, firewall 304-3 is more difficult to breach than is firewall 304-2, which is itself more difficult to breach than is firewall 304-1. It will be clear to those skilled in the art how to make and use firewalls 304-1 through 304-3.

Authentication Server 305 is a general-purpose computer with associated memory that authenticates wireless stations that seek access to resources 303-2 and 304-3. In accordance with the first illustrative embodiment of the present invention, authentication server 305 authenticates each wireless station through port one of access point 302. In accordance with the illustrative embodiment, the authentication is performed using the IEEE 802.11 or IEEE 802.11i authentication methods, ranging from shared key authentication in IEEE 802.11-1999 to Upper Layer Authentication (ULA) as defined in IEEE 802.11i Draft 2.0. It will be clear to those skilled in the art how to make and use authentication server 305.

FIG. 4 depicts a block diagram of the salient components of access point 302, which comprises: antenna 401, transmitter/receiver 402, general purpose processor 403, memory 404, port 405-1, port 405-2, and port 405-3, which are interconnected as shown.

Antenna 401 receives messages from and transmits messages to wireless stations 301-1 through 301-4 via radio. It will be clear to those skilled in the art how to make and use antenna 401.

Transmitter/receiver 402 receives access requests via antenna 401 from wireless stations 301-1 through 301-4. Transmitter/receiver 402 transmits these requests to processor 403. Transmitter/receiver receives replies from processor 403 and transmits these replies back through antenna 401. It will be clear to those skilled in the art how to make and use transmitter/receiver 402.

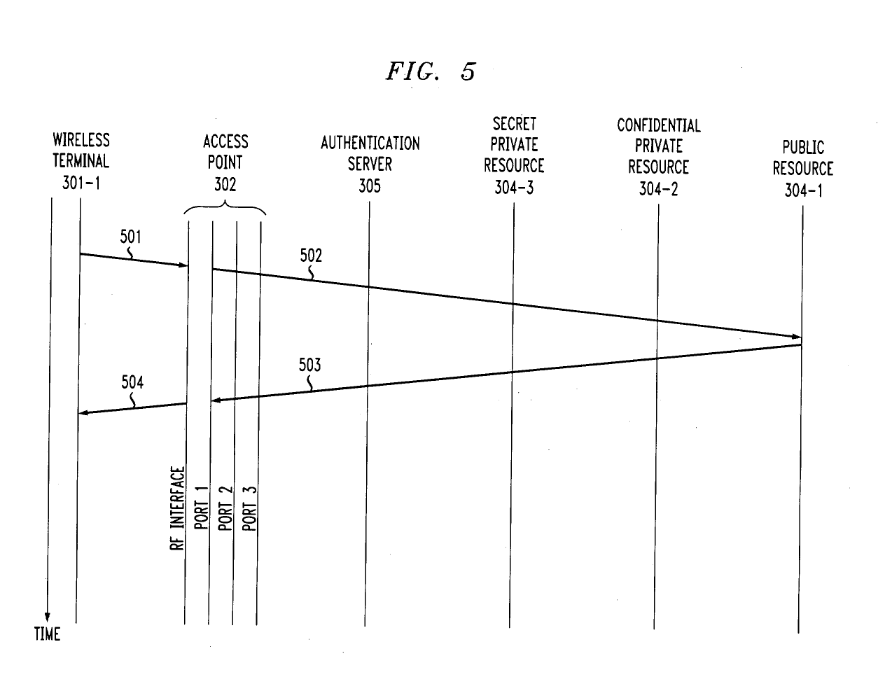

Processor 403 is a general-purpose computer that is capable of performing the functions described below and with respect to FIGS. 5 through 8.

Memory 404 stores the programs executed by processor 403 and stores the data used by processor 403 in providing access to resources 303-1 through 303-3. It will be clear to those skilled in the art how to make and use memory 404.

Ports 405-1, 405-2, and 405-3 are distinct physical input/output ports for the transmission of data on local area network 311 access point 302 to external resources. It will be clear to those skilled in the art, however, how to make and use alternative embodiments of the present invention in which some or all of the ports between the access point 302 and local area network 311 are logical ports on a single physical port. Whether ports 405-1, 405-2, and 405-3 are logical or physical, it will be clear to those skilled in the art how to make and use ports 405-1, 405-2, and 405-3.

In accordance with the first illustrative embodiment of the present invention, the external resources are accessed via three ports, each of which is associated with a different level of security. It will be clear to those skilled in the art, however, how to make and use alternative embodiments of the present invention that comprise a different number of ports.

In accordance with the first illustrative embodiment of the present invention, each port is associated with a different level of security. It will be clear to those skilled in the art, however, how to make and use alternative embodiments of the present invention in which each port is associated with:

i. a level of security, or

ii. an access privilege, or

iii. any combination of i and ii.

FIGS. 5 through 8 depict the message flows associated with the first illustrative embodiment of the present invention.

The messages depicted in FIGS. 5 through 8 pass between: one of wireless stations 301-1 through 301-4, access point 302, ports 405-1 through 405-3, authentication server 305, secret resource 304-3, confidential resource 304-2, and public resource 304-1.

FIG. 5 depicts the message flows associated with the first illustrative embodiment of the present invention for the case in which wireless station 301-1 seeks access to public resource 303-1.

At event 501, wireless station 301-1 transmits a request for access to public resource 304-1 to access point 302.

At event 502, access point 302 transmits the request to the public resource 304-1 via port 405-1 and firewall 304-1.

At event 503, public resource 304-1 transmits the requested information back to access point 302 via firewall 304-1 and port 405-1.

At event 504, access point 302 transmits the requested information back to wireless station 301-1.

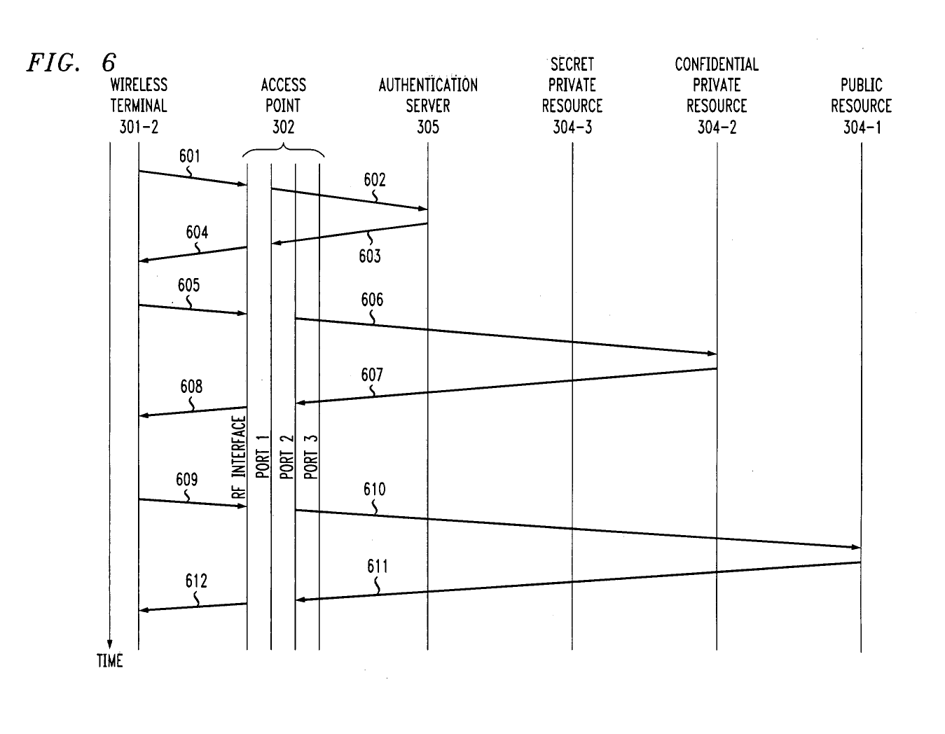

FIG. 6 depicts the message flows associated with the first illustrative embodiment of the present invention for the case in which wireless station 301-2 seeks access to both public resource 303-1 and confidential resource 303-2.

At event 601, wireless station 301-2 transmits a request to access point 302 to be authenticated for access to confidential resource 304-2. As part of this request, wireless station 301-2 transmits a password or other token that is evidence of its authority to access secret resource 304-2.

At event 602, access point 302 transmits the request to be authenticated and the password received from wireless station 301-2 to authentication server 305 via port 405-1.

At event 603, authentication server 305 authenticates wireless station 301-2 and transmits an indication of that authentication to access point 302 via port 405-1.

At event 604, access point 302 transmits to wireless station 301-2 an indication that wireless station 301-2 has been authenticated to access confidential resource 304-2.

At event 605, wireless station 301-2 transmits to access point 302 a request for information from confidential resource 304-2.

At event 606, access point 302 transmits the request for information to confidential resource 304-2 via port 405-2.

At event 607, confidential resource 304-2 transmits the requested information back to access point 302 via port 405-2.

At event 608, access point 302 transmits the requested information back to wireless station 301-2.

At event 609, wireless station 301-2 transmits a request for access to public resource 304-1 to access point 302.

At event 610, access point 302 retrieves data from memory 404 indicating that wireless station 302-2 had been previously authenticated to request information from confidential resource 304-2. Therefore, access point 302 transmits the request to the public resource via port 405-2 and firewall 304-1.

At event 611, public resource 304-1 transmits the requested information back to access point 302 via firewall 304-1 and port 405-2.

At event 612, access point 302 transmits the requested information back to wireless station 301-2.

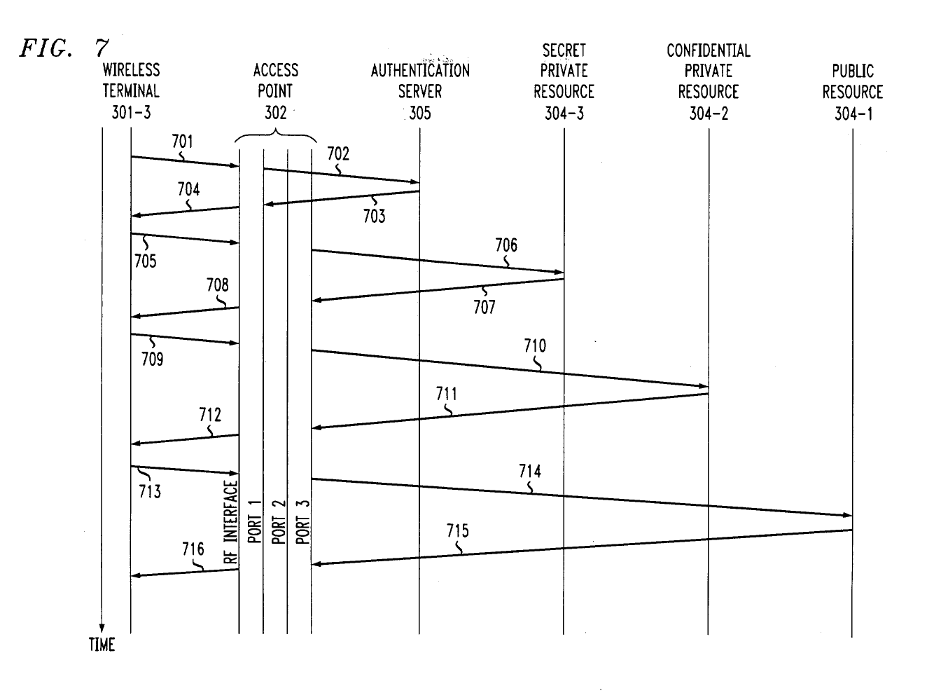

FIG. 7 depicts the message flows associated with the first illustrative embodiment of the present invention for the case in which wireless station 301-3 seeks access to public resource 303-1, a confidential resource 303-2, and secret resource 303-3.

At event 701, wireless station 301-3 transmits a request to be authenticated to access secret resource 304-2 to access point 302. As part of this request, wireless station 301-3 transmits a password or other token that is evidence of its authority to access secret resource 304-3.

At event 702, access point 302 transmits the request to be authenticated for access to secret resource 304-3 and the password or other token to authentication server 305 via port 405-1.

At event 703, authentication server 305 authenticates wireless station 301-3 and transmits an indication of that authentication to access point 302 via port 405-1.

At event 704, access point 302 transmits to wireless station 301-3 an indication that wireless station 301-3 has been authenticated to access secret resource 304-3.

At event 705, wireless station 301-3 transmits a request for information from secret resource 304-3 to access point 302.

At event 706, access point 302 transmits the request for information to secret resource 304-2 via port 405-3. The reason that transmission is over port 405-3 instead of 405-1 is to segregate secret resource 304-3 from both public resource 304-1 and confidential resource 304-2 with a single wireless local area network.

At event 707, secret resource 304-2 transmits the requested information back to access point 302 via port 405-3.

At event 708, access point 302 transmits the requested information back to wireless station 301-3.

Once access is granted to secret resource 304-3, wireless station 301-3 also has access to confidential resource 304-2 via firewall 304-2 in events 709-712 and to public resource 304-1 via both firewall 304-2 and firewall 304-1 in events 713-716. All transmissions are over port 405-3. Access to confidential resource 304-2 by wireless station 301-3 is made possible via events 709-712.

At event 709, wireless station 301-3 transmits a request for access to confidential resource 304-2 to access point 302.

At event 710, access point 302 retrieves data from memory 404 indicating that wireless station 302-3 had been previously authenticated to request information from secret resource 304-3. Therefore, access point 302 transmits the request to confidential resource 304-2 via port 405-3 and firewall 304-2.

At event 711, confidential resource 304-2 transmits the requested information back to access point 302 via firewall 304-2 and port 405-3.

At event 712, access point 302 transmits the requested information back to wireless station 301-3.

Access to public resource 304-1 is made possible via tasks 713-716.

At event 713, wireless station 301-3 transmits a request for access to public resource 304-1 to access point 302.

At event 714, access point 302 retrieves data from memory 404 indicating that wireless station 302-3 had been previously authenticated to request information from secret resource 304-3. Therefore, access point 302 transmits the request to public resource 304-1 via port 405-3, firewall 304-2, and firewall 304-1.

At event 715, public resource 304-1 transmits the requested information back to access point 302 via firewall 304-1, firewall 304-2, and port 405-3.

At event 716, access point 302 transmits the requested information back to wireless station 301-3.

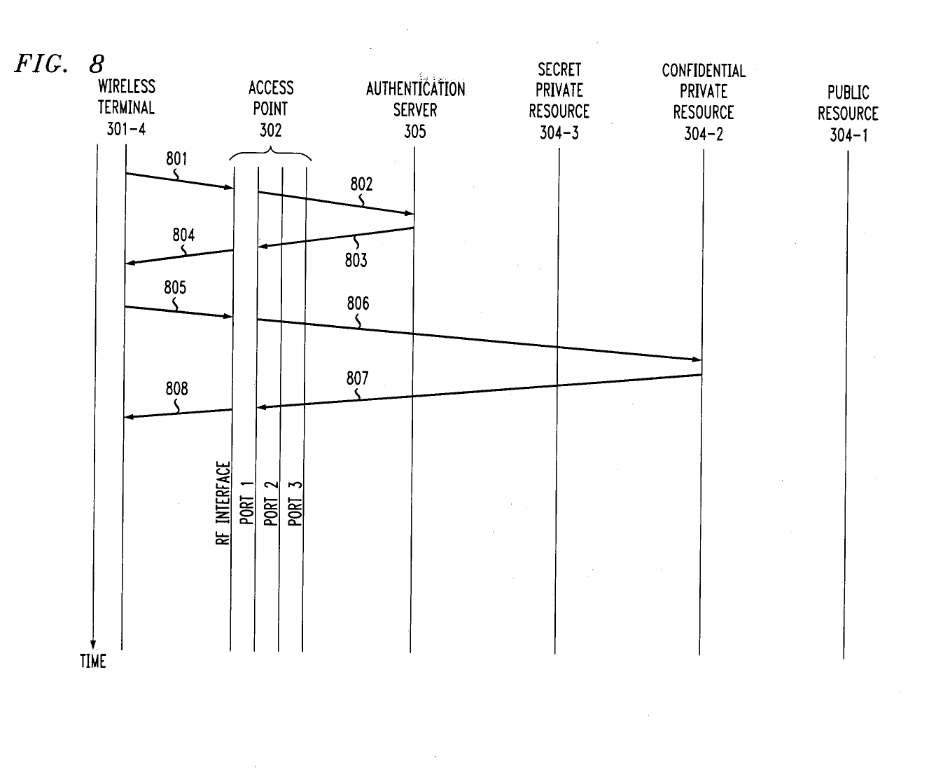

FIG. 8 depicts the message flows associated with the first illustrative embodiment of the present invention for the case in which wireless station 301-4 seeks access to secret resource 304-3 and public resource 304-1, but fails to be authenticated to access secret resource 304-3.

At event 801, wireless station 301-4 transmits a request to be authenticated to access secret resource 304-3 to access point 302. As part of this request, wireless station 301-4 transmits a password or other token purporting to be evidence of its authority to access secret resource 304-3.

At event 802, access point 302 transmits the request to be authenticated for access to secret resource 304-3 and the password or other token to authentication server 305 via port 405-1.

At event 803, authentication server 305 fails to authenticate wireless station 301-4 and transmits an indication of that failure of authentication to access point 302 via port 405-1.

At event 804, access point 302 transmits to wireless station 301-4 an indication that wireless station 301-4 has not been authenticated to access secret resource 304-3.

Access to a public resource by wireless station 301-4 is made possible via events 705-708.

At event 805, wireless station 301-4 transmits a request for access to public resource 304-1 to access point 302.

At event 806, access point 302 retrieves data from memory 404 indicating that wireless station 302-4 had previously failed to be authenticated to request information from secret resource 304-3. Therefore, access point 302 transmits the request to the public resource via port 405-1 and firewall 304-1.

At event 807, public resource 304-1 transmits the requested information back to access point 302 via firewall 304-1 and port 405-1.

At event 808, access point 302 transmits the requested information back to wireless station 301-4.

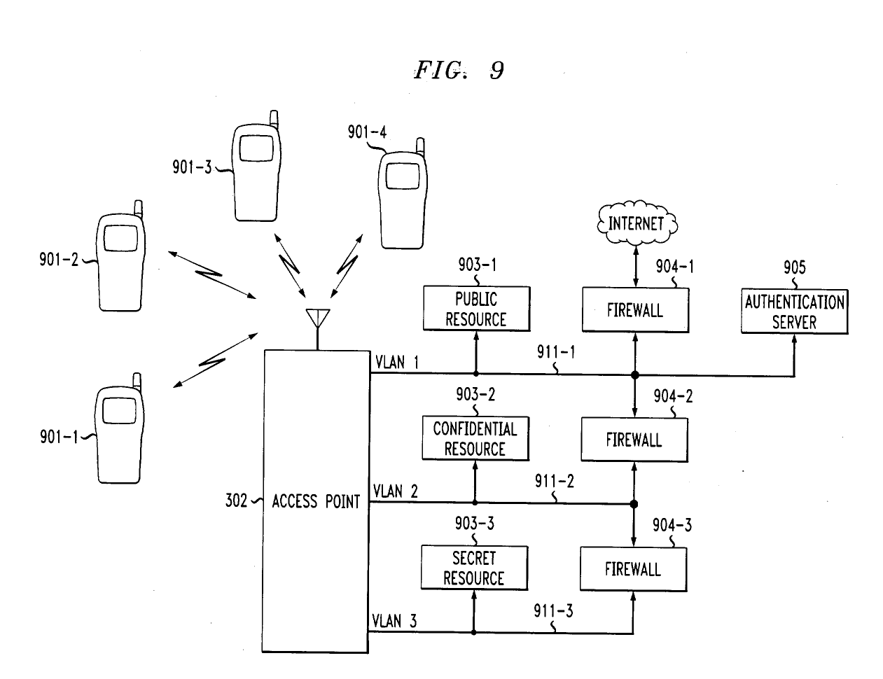

FIG. 9 depicts a block diagram of the salient components of the second illustrative embodiment of the present invention. Telecommunications system 900 comprises: wireless stations 901-1 through 901-4, access point 902, public resource 903-1, confidential resource 903-2, secret resource 903-3, firewalls 904-1 through 904-3, authentication server 905, wireless local area network 910, wireline local area network 911, and the Internet, which are interconnected as shown.

Wireless local area network 910 is IEEE 802.11-compliant as are wireless stations 901-1 through 901-4 and access point 902. It will be clear to those skilled in the art how to make and use wireless stations 901-1 through 901-4. Furthermore, it will be clear to those skilled in the art, after reading this specification, how to make and use embodiments of the present invention in which wireless local area network 910 operates in accordance with a different protocol.

Wireline local area network 911 is a single Ethernet-compliant physical local area network on which three logically-distinct virtual local area networks are superimposed in well-known fashion. Access point 902, firewalls 903-1 and 903-2, public resource 904-1, confidential resource 904-2, secret resource 904-3, and authentication server 905 are all Ethernet-compliant. It will be clear to those skilled in the art how to make and use firewalls 903-1 and 903-2, public resource 904-1, confidential resource 904-2, secret resource 904-3, and authentication server 905. Furthermore, it will be clear to those skilled in the art, after reading this specification, how to make and use embodiments of the present invention in which local area network 911 operates in accordance with a different protocol.

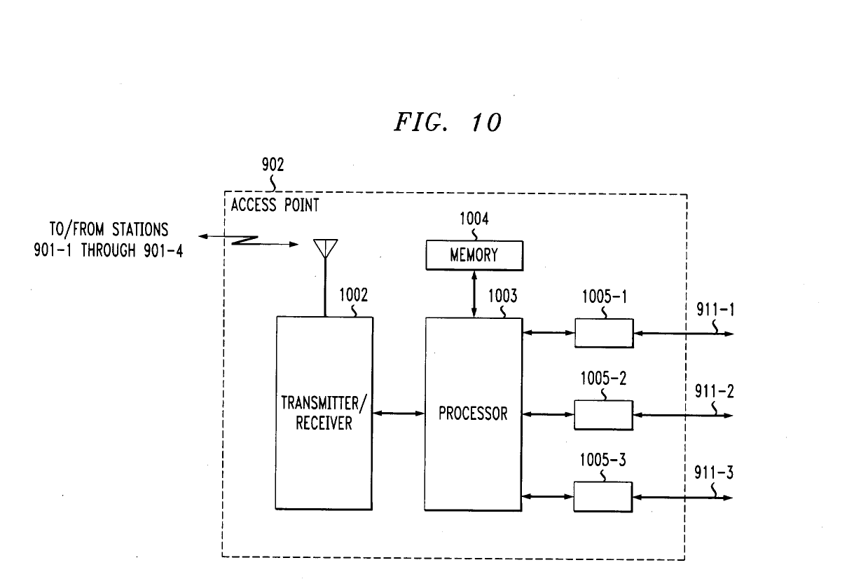

Access point 902 provides a bridge through which both authorized and unauthorized (i.e., guest) wireless stations can access both public and private resources based on their respective security and privilege level. The details of access point 902 are described below and with respect to FIG. 10.

Resources 903-1 through 903-3 are general-purpose computers that comprise information (e.g., databases, web sites, etc.) that the users of wireless stations 901-1 through 901-4 might desire to access. In accordance with the illustrative embodiment, resource 903-1 comprises public information that can be accessed freely by anyone for any purpose. In contrast, resources 903-2 and 903-3 comprise private information that can be accessed only by individuals with the privilege level to do so. Furthermore, resource 903-2 comprises secret information, which is more closely guarded than is the information in confidential resource 903-2. Confidential resource 903-2 is configured to only accept traffic emanating from virtual local area network 903-2 of access point 902 and secret resource is configured to only accept traffic emanating from virtual local area network 903-3 of access point 902. It will be clear to those skilled in the art how to make and use resources 903-1 through 904-3.

Firewalls 904-1 through 904-3 are each general-purpose computers that prevent unauthorized access to the resources behind them. Because of the relative sensitivity of the data in public resource 903-1, confidential resource 903-2, and secret resource 903-3, firewall 904-3 is more difficult to breach than is firewall 904-2, which is itself more difficult to breach than is firewall 904-1. It will be clear to those skilled in the art how to make and use firewalls 904-1 through 904-3.

Authentication Server 905 is a general-purpose computer with associated memory that authenticates wireless stations that seek access to resources 903-2 and 904-3. In accordance with the second illustrative embodiment of the present invention, authentication server 905 authenticates each wireless station through virtual local area network one of access point 902. In accordance with the illustrative embodiment, the authentication is performed using the IEEE 802.11 or IEEE 802.11i authentication methods, ranging from shared key authentication in IEEE 802.11-1999 to Upper Layer Authentication (ULA) as defined in IEEE 802.11i Draft 2.0. It will be clear to those skilled in the art how to make and use authentication server 905.

FIG. 10 depicts a block diagram of the salient components of access point 902, which comprises: antenna 1001, transmitter/receiver 1002, general purpose processor 1003, memory 1004, virtual local area network 903-1005-1, virtual local area network 903-1005-2, and virtual local area network 903-1005-3, which are interconnected as shown.

Antenna 1001 receives messages from and transmits messages to wireless stations 901-1 through 901-4 via radio. It will be clear to those skilled in the art how to make and use antenna 1001.

Transmitter/receiver 1002 receives access requests via antenna 1001 from wireless stations 901-1 through 901-4. Transmitter/receiver 1002 transmits these requests to processor 1003. Transmitter/receiver receives replies from processor 1003 and transmits these replies back through antenna 1001. It will be clear to those skilled in the art how to make and use transmitter/receiver 1002.

Processor 1003 is a general-purpose computer that is capable of performing the functions described below and with respect to FIGS. 10 through 8.

Memory 1004 stores the programs executed by processor 1003 and stores the data used by processor 1003 in providing access to resources 903-1 through 903-3. It will be clear to those skilled in the art how to make and use memory 1004.

In accordance with the second illustrative embodiment of the present invention, the external resources are accessed via three virtual local area networks, each of which-is associated with a different level of security. It will be clear to those skilled in the art, however, how to make and use alternative embodiments of the present invention that comprise a different number of virtual local area networks.

In accordance with the second illustrative embodiment of the present invention, each virtual local area network is associated with a different level of security. It will be clear to those skilled in the art, however, how to make and use alternative embodiments of the present invention in which each virtual local area network is associated with:

i. a level of security, or

ii. an access privilege, or

iii. any combination of i and ii.

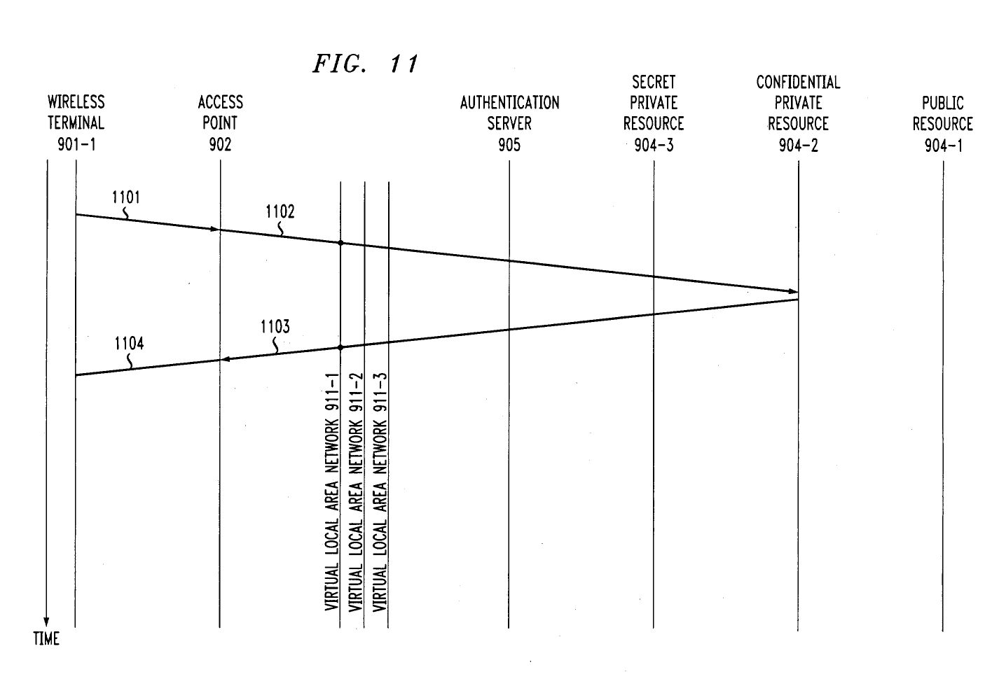

FIGS. 11 through 14 depict the message flows associated with the first illustrative embodiment of the present invention.

The messages depicted in FIGS. 11 through 14 pass between: one of wireless stations 901-1 through 901-4, access point 902, virtual local area networks 1005-1 through 1005-3, authentication server 905, secret resource 904-3, confidential resource 904-2, and public resource 904-1.

FIG. 11 depicts the message flows associated with the first illustrative embodiment of the present invention for the case in which wireless station 901-1 seeks access to public resource 903-1.

At event 1101, wireless station 901-1 transmits a request for access to public resource 904-1 to access point 902.

At event 1102, access point 902 transmits the request to the public resource 904-1 via virtual local area network 1005-1 and firewall 904-1.

At event 1103, public resource 904-1 transmits the requested information back to access point 902 via firewall 904-1 and virtual local area network 1005-1.

At event 1104, access point 902 transmits the requested information back to wireless station 901-1.

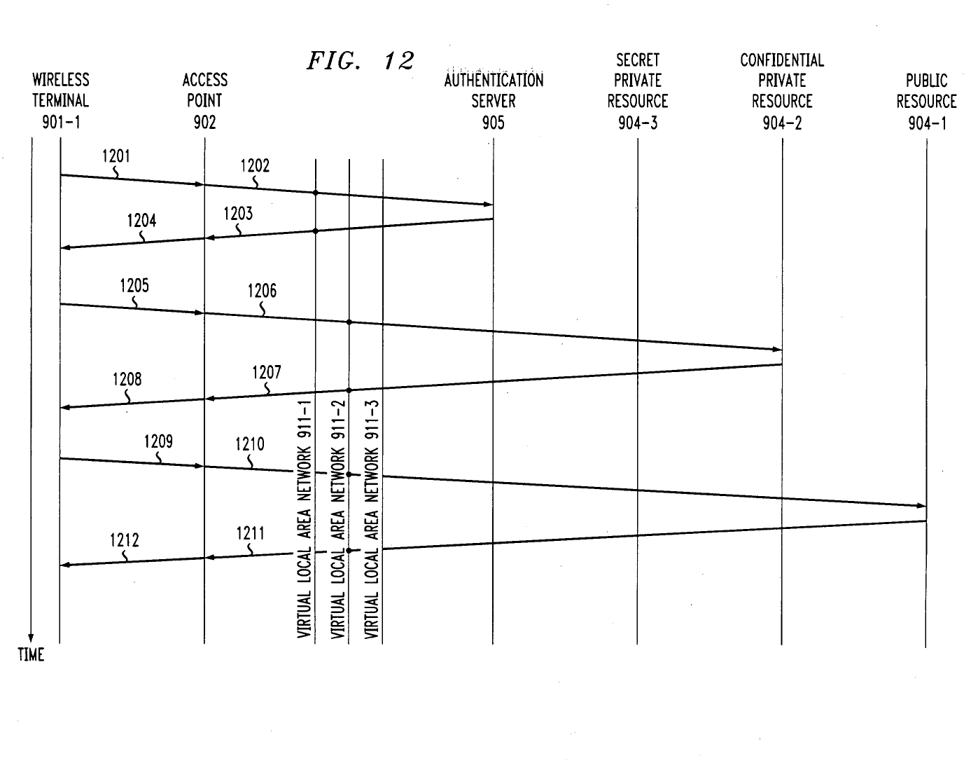

FIG. 12 depicts the message flows associated with the first illustrative embodiment of the present invention for the case in which wireless station 901-2 seeks access to both public resource 903-1 and confidential resource 903-2.

At event 1201, wireless station 901-2 transmits a request to access point 902 to be authenticated for access to confidential resource 904-2. As part of this request, wireless station 901-2 transmits a password or other token that is evidence of its authority to access secret resource 904-2.

At event 1202, access point 902 transmits the request to be authenticated and the password received from wireless station 901-2 to authentication server 905 via virtual local area network 1005-1.

At event 1203, authentication server 905 authenticates wireless station 901-2 and transmits an indication of that authentication to access point 902 via virtual local area network 1005-1.

At event 1204, access point 902 transmits to wireless station 901-2 an indication that wireless station 901-2 has been authenticated to access confidential resource 904-2.

At event 1205, wireless station 901-2 transmits to access point 902 a request for information from confidential resource 904-2.

At event 1206, access point 902 transmits the request for information to confidential resource 904-2 via virtual local area network 1005-2.

At event 1207, confidential resource 904-2 transmits the requested information back to access point 902 via virtual local area network 1005-2.

At event 1208, access point 902 transmits the requested information back to wireless station 901-2.

At event 1209, wireless station 901-2 transmits a request for access to public resource 904-1 to access point 902.

At event 1210, access point 902 retrieves data from memory 1004 indicating that wireless station 902-2 had been previously authenticated to request information from confidential resource 904-2. Therefore, access point 902 transmits the request to the public resource via virtual local area network 1005-2 and firewall 904-1.

At event 1211, public resource 904-1 transmits the requested information back to access point 902 via firewall 904-1 and virtual local area network 1005-2.

At event 1212, access point 902 transmits the requested information back to wireless station 901-2.

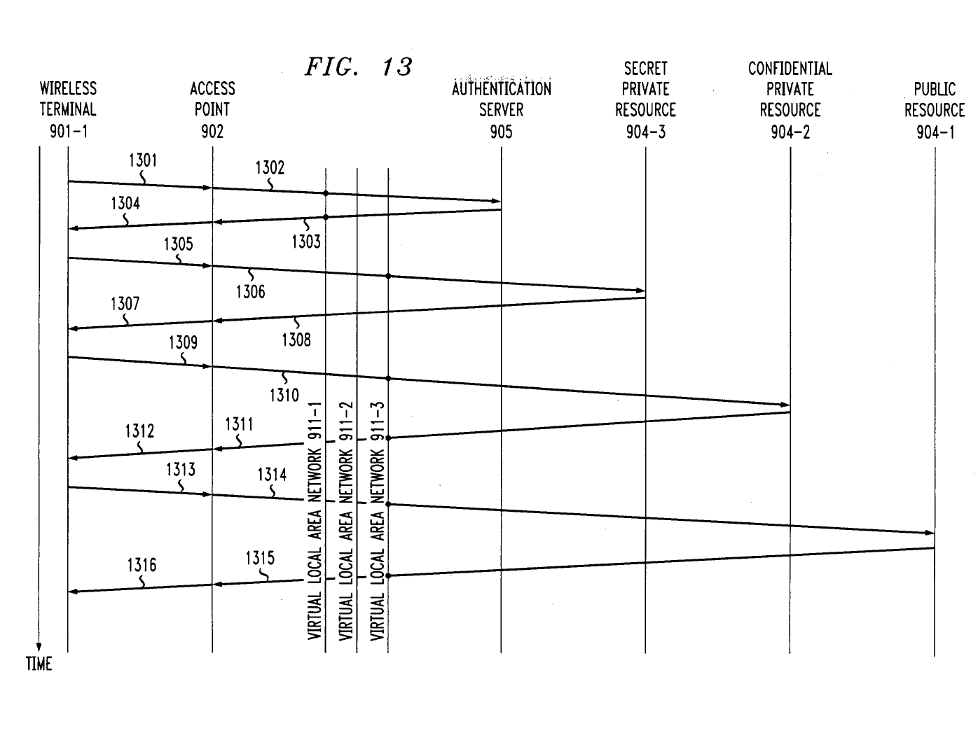

FIG. 13 depicts the message flows associated with the first illustrative embodiment of the present invention for the case in which wireless station 901-3 seeks access to public resource 903-1, a confidential resource 903-2, and secret resource 903-3.

At event 1301, wireless station 901-3 transmits a request to be authenticated to access secret resource 904-2 to access point 902. As part of this request, wireless station 901-3 transmits a password or other token that is evidence of its authority to access secret resource 904-3.

At event 1302, access point 902 transmits the request to be authenticated for access to secret resource 904-3 and the password or other token to authentication server 905 via virtual local area network 1005-1.

At event 1303, authentication server 905 authenticates wireless station 901-3 and transmits an indication of that authentication to access point 902 via virtual local area network 1005-1.

At event 1304, access point 902 transmits to wireless station 901-3 an indication that wireless station 901-3 has been authenticated to access secret resource 904-3.

At event 1305, wireless station 901-3 transmits a request for information from secret resource 904-3 to access point 902.

At event 1306, access point 902 transmits the request for information to secret resource 904-2 via virtual local area network 1005-3. The reason that transmission is over virtual local area network 1005-3 instead of 1005-1 is to segregate secret resource 904-3 from both public resource 904-1 and confidential resource 904-2 with a single wireless local area network.

At event 1307, secret resource 904-2 transmits the requested information back to access point 902 via virtual local area network 1005-3.

At event 1308, access point 902 transmits the requested information back to wireless station 901-3.

Once access is granted to secret resource 904-3, wireless station 901-3 also has access to confidential resource 904-2 via firewall 904-2 in events 1309-712 and to public resource 904-1 via both firewall 904-2 and firewall 904-1 in events 1313-716. All transmissions are over virtual local area network 1005-3. Access to confidential resource 904-2 by wireless station 901-3 is made possible via events 1309-712.

At event 1309, wireless station 901-3 transmits a request for access to confidential resource 904-2 to access point 902.

At event 1310, access point 902 retrieves data from memory 1004 indicating that,wireless station 902-3 had been previously authenticated to request information from secret resource 904-3. Therefore, access point 902 transmits the request to confidential resource 904-2 via virtual local area network 1005-3 and firewall 904-2.

At event 1311, confidential resource 904-2 transmits the requested information back to access point 902 via firewall 904-2 and virtual local area network 1005-3.

At event 1312, access point 902 transmits the requested information back to wireless station 901-3.

Access to public resource 904-1 is made possible via tasks 1313-1316.

At event 1313, wireless station 901-3 transmits a request for access to public resource 904-1 to access point 902.

At event 1314, access point 902 retrieves data from memory 1004 indicating that wireless station 902-3 had been previously authenticated to request information from secret resource 904-3. Therefore, access point 902 transmits the request to public resource 904-1 via virtual local area network 1005-3, firewall 904-2, and firewall 904-1.

At event 1315, public resource 904-1 transmits the requested information back to access point 902 via firewall 904-1, firewall 904-2, and virtual local area network 1005-3.

At event 1316, access point 902 transmits the requested information back to wireless station 901-3.

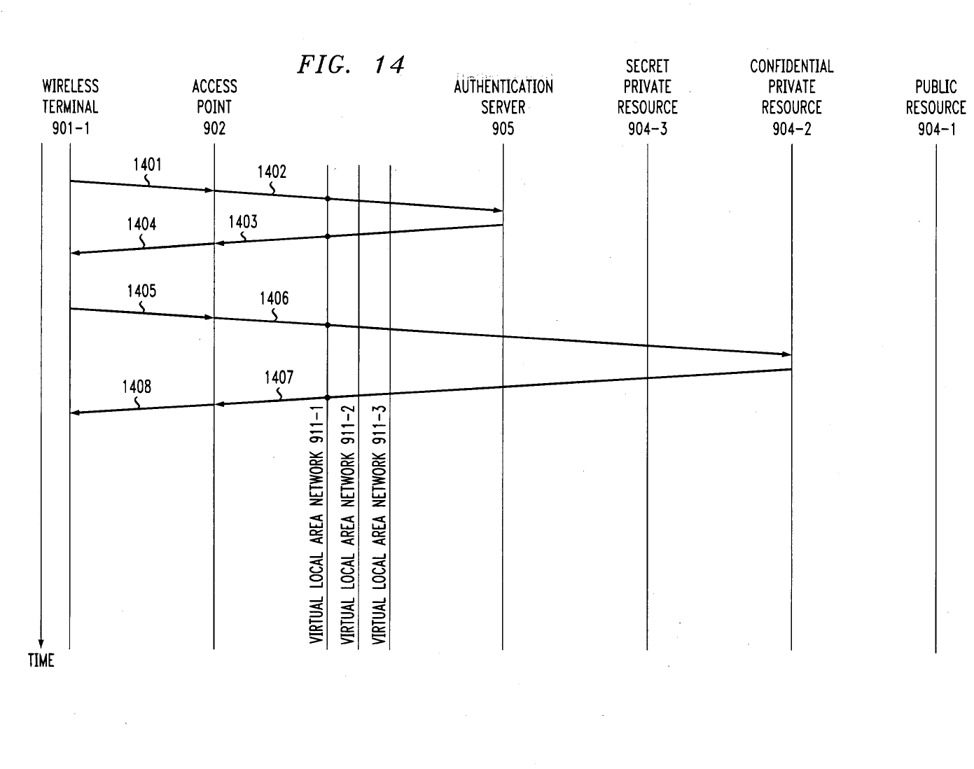

FIG. 14 depicts the message flows associated with the first illustrative embodiment of the present invention for the case in which wireless station 901-4 seeks access to secret resource 904-3 and public resource 904-1, but fails to be authenticated to access secret resource 904-3.

At event 1401, wireless station 901-4 transmits a request to be authenticated to access secret resource 904-3 to access point 902. As part of this request, wireless station 901-4 transmits a password or other token to virtual local area networking to be evidence of its authority to access secret resource 904-3.

At event 1402, access point 902 transmits the request to be authenticated for access to secret resource 904-3 and the password or other token to authentication server 905 via virtual local area network 1005-1.

At event 1403, authentication server 905 fails to authenticate wireless station 901-4 and transmits an indication of that failure of authentication to access point 902 via virtual local area network 1005-1.

At event 1404, access point 902 transmits to wireless station 901-4 an indication that wireless station 901-4 has not been authenticated to access secret resource 904-3.

Access to a public resource by wireless station 901-4 is made possible via events 1305-708.

At event 1405, wireless station 901-4 transmits a request for access to public resource 904-1 to access point 902.

At event 1406, access point 902 retrieves data from memory 1004 indicating that wireless station 902-4 had previously failed to be authenticated to request information from secret resource 904-3. Therefore, access point 902 transmits the request to the public resource via virtual local area network 1005-1 and firewall 904-1.

At event 1407, public resource 904-1 transmits the requested information back to access point 902 via firewall 904-1 and virtual local area network 1005-1.

At event 1408, access point 902 transmits the requested information back to wireless station 901-4.

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

What is claimed is:

1. A method comprising:
receiving a request from a first wireless station for access to a first resource, wherein said first wireless station offers to authenticate itself as authorized to access said first resource;
authenticating said first wireless station through a first port; and,
providing access for said first wireless station to said first resource through a second port after said first wireless station has been authenticated as authorized to access said first resource.

2. The method of claim 1 further comprising:
receiving a request from a second wireless station for access to a public resource; and
providing access for said second wireless station to said public resource through said first port.

3. The method of claim 2 wherein said first wireless station is provided access to said public resource through said second port.

4. The method of claim 1 further comprising:
receiving a request from a second wireless station for access to a second resource, wherein said second wireless station offers to authenticate itself as authorized to access said second resource;
authenticating said second wireless station through said first port; and
providing access for said second wireless station to said first resource through a third port after said second wireless station has been authenticated as authorized to access said second resource.

5. The method of claim 4 wherein said second wireless station is provided access to said first resource through said third port.

6. The method of claim 4 wherein said second wireless station is provided access to a public resource through said third port.

7. A method comprising:
receiving a request from a first wireless station for access to a first resource, wherein said first wireless station offers to authenticate itself as authorized to access said first resource;
authenticating said first wireless station through a first network; and,
providing access for said first wireless station to said first resource through a second network after said first wireless station has been authenticated as authorized to access said first resource.

8. The method of claim 7 wherein said first network is a first local area network, and said second network is a second local area network.

9. The method of claim 8 wherein said first local area network is a first virtual local area network, and said second network is a second virtual local area network.

10. The method of claim 7 further comprising:
receiving a request from a second wireless station for access to a public resource; and
providing access for said second wireless station to said public resource through said first network.

11. The method of claim 10 wherein said first wireless station is provided access to said public resource through said second network.

12. The method of claim 7 further comprising:
receiving a request from a second wireless station for access to a second resource, wherein said second wireless station offers to authenticate itself as authorized to access said second resource;
authenticating said second wireless station through said first network; and
providing access for said second wireless station to said first resource through a third network after said second wireless station has been authenticated as authorized to access said second resource.

13. The method of claim 12 wherein said second wireless station is provided access to said first resource through said third network.

14. The method of claim 12 wherein said second wireless station is provided access to a public resource through said third network.

15. An apparatus comprising:
a first port;
a second port;
a receiver for receiving a request from a first wireless station for access to a first resource, wherein said first wireless station offers to authenticate itself as authorized to access said first resource; and
a transmitter for authenticating said first wireless station through said first port, and for providing access for said first wireless station to said first resource through said second port after said first wireless station has been authenticated as authorized to access said first resource.

16. The apparatus of claim 15 wherein said receiver is also for receiving a request from a second wireless station for access to a public resource; and
wherein said transmitter is also for providing access for said second wireless station to said public resource through said first port.

17. The apparatus of claim 16 wherein said first wireless station is provided access to said public resource through said second port.

18. The apparatus of claim 15 wherein
said receiver receives a request from a second wireless station for access to a second resource, wherein said second wireless station offers to authenticate itself as authorized to access said second resource;
said transmitter conducts the authentication of said second wireless station through said first port, and said transmitter providing access for said second wireless station to said first resource through a third port after said second wireless station has been authenticated as authorized to access said second resource.

19. The apparatus of claim 18 wherein said second wireless station is provided access to said first resource through said third port.

20. The apparatus of claim 18 wherein said second wireless station is provided access to a public resource through said third port.

21. An apparatus comprising:
a first network;
a second network;
a receiver for receiving a request from a first wireless station for access to a first resource, wherein said first wireless station offers to authenticate itself as authorized to access said first resource; and
a transmitter for authenticating said first wireless station through said first network, and for providing access for said first wireless station to said first resource through said second network after said first wireless station has been authenticated as authorized to access said first resource.

22. The method of claim 21 wherein said first network is a first local area network, and said second network is a second local area network.

23. The method of claim 22 wherein said first local area network is a first virtual local area network, and said second network is a second virtual local area network.

24. The apparatus of claim 21 wherein said receiver is also for receiving a request from a second wireless station for access to a public resource; and
wherein said transmitter is also for providing access for said second wireless station to said public resource through said first network.

25. The apparatus of claim 24 wherein said first wireless station is provided access to said public resource through said second network.

26. The apparatus of claim 21 wherein
said receiver receives a request from a second wireless station for access to a second resource, wherein said second wireless station offers to authenticate itself as authorized to access said second resource;
said transmitter conducts the authentication of said second wireless station through said first network, and said transmitter providing access for said second wireless station to said first resource through a third network after said second wireless station has been authenticated as authorized to access said second resource.

27. The apparatus of claim 26 wherein said second wireless station is provided access to said first resource through said third network.

28. The apparatus of claim 26 wherein said second wireless station is provided access to a public resource through said third network.
